(19) United States
(12) Patent Application Publication
(10) Pub. No.: US 2008/0041179 A1
(43) Pub. Date: Feb. 21, 2008

(54) AUTOMATIC TRANSMISSION

(75) Inventors: Kenjiro YASUI, Shizuoka (JP); Naoto Satou, Shizuoka (JP)

Correspondence Address: FOLEY AND LARDNER LLP;SUITE 500, 3000 K STREET NW, WASHINGTON, DC, 20007, US

(73) Assignee: JATCO Ltd

(21) Appl. No.: 11/773,679

(22) Filed: Jul. 5, 2007

(30) Foreign Application Priority Data
Jul. 6, 2006 (JP) 2006-186371

(51) Int. Cl. F16H 57/04

(52) U.S. Cl. 74/467; 74/606 R

(57) ABSTRACT

In an automatic transmission having an air breather chamber for separating oil and air, entering the air breather chamber as oil bubbles, a shielding rib is located below an air-breather opening serving as an inlet-and-return port, for preventing oil, stored in a transmission casing assembly and splashed by rotary motion of a transmission rotating component part, from directly reaching the air-breather opening. An upside of the shielding rib is configured to be inclined downwardly with respect to a horizontal line in such a manner as to be oriented toward the transmission rotating component part, for receiving oil dripping through the air-breather opening with the upside of the shielding rib and for rapidly delivering the received oil toward the transmission rotating component part, using the inclined upside of the shielding rib.

### TECHNICAL FIELD

The present invention relates to an automatic transmission having an air breather (an air breathing mechanism).

### BACKGROUND ART

As is generally known, in automatic transmissions capable of automatically executing both upshifting and downshifting, a predetermined amount of oil (working fluid) is stored in a transmission casing assembly. In order to prevent actual contact between any of moving metal surfaces, the oil is supplied to moving or rotating transmission parts, such as bearing parts or gears in meshed-engagement. In multi-disc type automatic transmissions, friction elements are selectively engaged (applied) or disengaged (released) by way of hydraulic pressure application or hydraulic pressure release, so as to achieve a desired shift step. In belt-drive continuously variable transmissions (CVTs), each of which uses an endless drive belt, such as an endless segmented steel belt, running in a pair of variable-width pulleys, namely primary and secondary—driving and driven—pulleys whose effective diameters are continuously variable by virtue of hydraulic pressure to provide varying pulley ratios (transmission ratios), thus achieving a desired shift step.

During operation of an automatic transmission (or an automatic transaxle), an internal pressure in the transmission casing assembly tends to rise due to frictional heat and the like. To escape the internal pressure from the transmission casing assembly to the atmosphere and thus to reduce the pressure difference between inside and outside of the transmission casing assembly, an air breather hole is provided at the upper portion of the transmission casing assembly accommodating therein the transmission moving component parts.

Generally, a plurality of moving or rotating component parts are employed in the automatic transmission. During rotation of the transmission rotating component parts, oil, stored in the transmission casing assembly, is agitated and thus oil bubbles are produced. During operation of the automatic transmission, these oil bubbles rise to the air breather hole provided at the transmission-casing upper portion. Owing to a rise in internal pressure and the oil bubbles rising to the air breather hole, there is a possibility that the oil is forcibly discharged or spout out together with air.

To avoid this, an automatic transmission is often provided with an air breather chamber having a labyrinthine structure. The air breather chamber of the labyrinthine structure is formed in the transmission casing assembly in such a manner as to communicate with the air breather hole (an outlet) via labyrinth air-breathing passages. In the automatic transmission having the air breather chamber of the labyrinthine structure, when the oil bubbles pass through the labyrinth air breather chamber, the oil (working fluid) and the gas (air) are separated from each other within the air breather chamber and as a result only the gas (air) can be exhausted out of the transmission casing assembly. One such labyrinth-air-breather-chamber equipped automatic transmission has been disclosed in Japanese Patent Provisional Publication No. 2005-291263 (hereinafter is referred to as “JP2005-291263”). By virtue of the labyrinthine structure of the air breather chamber as disclosed in JP2005-291263, in a process that oil bubbles, entering through an air-breather lower opening (an inlet) formed in the vicinity of the lower portion of the air breather chamber, rise to the air breather hole, oil (working fluid) and gas (air), entering the air breather chamber as oil bubbles, can be certainly separated from each other. The oil (working fluid), separated from the gas (air), is returned via the air-breather lower opening to the internal space of the transmission casing assembly for lubrication, while only the gas (air), separated from the oil (working fluid), is exhausted or escaped out of the transmission casing assembly via the air breather hole.

In addition to the entry of any oil, entering the air breather chamber as the previously-discussed oil bubbles, however, there is an increased tendency for oil, splashed or flung up by a transmission rotating component part, such as a differential device including a final drive gear and incorporated in an automatic transmission (an automatic transaxle), to directly enter the air breather chamber. In the case of the latter oil entry, that is, the direct entry of the splashed oil into the air breather chamber, it is difficult to return the oil via the air-breather opening into the internal space of the transmission casing assembly.

To avoid this, in the automatic transmission of JP2005-291263, a baffle plate is also provided between the transmission rotating component part (e.g., the differential device) and the air-breather opening (air-breather inlet) to prevent the oil, splashed or flung up from the rotating part, from directly entering or reaching the air-breather opening.

### SUMMARY OF THE INVENTION

However, there is a possibility that the oil (working fluid), which is separated from the gas (air) within the air breather chamber and then drips through the air-breather opening, is disturbed or obstructed by the previously-noted baffle plate, provided between the transmission rotating part and the air-breather opening. That is, the baffle-plate equipped automatic transmission as disclosed in JP2005-291263 has the difficulty in efficiently supplying or returning the oil from the air breather chamber to the transmission rotating part (e.g., the differential).

It is, therefore, in view of the previously-described disadvantages of the prior art, an object of the invention to provide an automatic transmission capable of efficiently supplying oil, separated from gas (air) within an air breather chamber of an air breather (an air breathing mechanism), into transmission moving or rotating component parts, while preventing oil stored in a transmission casing assembly from directly reaching an air-breather opening.

In order to accomplish the aforementioned and other objects of the present invention, an automatic transmission comprises a transmission casing assembly accommodating therein at least one transmission rotating component part, an air breather chamber provided in the transmission casing assembly for separating oil and air, entering the air breather chamber as oil bubbles, an air breather hole formed in the transmission casing assembly in such a manner as to penetrate the transmission casing assembly for communicating the air breather chamber with an exterior space of the transmission casing assembly through the air breather hole, an air-breather opening that intercommunicates an internal space of the transmission casing assembly and the air breather chamber, and a shielding rib located below the air-breather opening and extending from an inner wall of the transmission casing assembly, for preventing oil, stored in the transmission casing assembly, from directly reaching the air-breather opening, an upside of the shielding rib being configured to be inclined downwardly with respect to a horizontal line in such a manner as to be oriented toward the transmission rotating component part, for receiving oil dripping through the air-breather opening with the upside of the shielding rib and for delivering the received oil toward the transmission rotating component part, using the inclined upside of the shielding rib.

According to another aspect of the invention, an automatic transmission comprises a transmission casing assembly accommodating therein at least one transmission rotating component part and comprising a converter housing having a mating face formed on an opening end and a transmission case having a mating face formed on an opening end, both of the mating faces fitted to each other when assembling, an integrated air breather chamber provided in the transmission casing assembly and located adjacent to the mating faces and comprising a converter-housing side air breather chamber and a transmission-case side air breather chamber integrally connected to each other for defining a labyrinthine air-breathing space and for separating oil and air, entering the air breather chamber as oil bubbles, an air breather hole formed in the transmission casing assembly in such a manner as to penetrate the transmission casing assembly for communicating the air breather chamber with an exterior space of the transmission casing assembly through the air breather hole, an air-breather opening that intercommunicates an internal space of the transmission casing assembly and the air breather chamber, and a shielding rib located below the air-breather opening and extending from an inner wall of the transmission casing assembly, for preventing oil, stored in the transmission casing assembly, from directly reaching the air-breather opening, an upside of the shielding rib being configured to be inclined downwardly with respect to a horizontal line in such a manner as to be oriented toward the transmission rotating component part, for receiving oil dripping through the air-breather opening with the upside of the shielding rib and for delivering the received oil toward the transmission rotating component part, using the inclined upside of the shielding rib.

The other objects and features of this invention will become understood from the following description with reference to the accompanying drawings.

### BRIEF DESCRIPTION OF THE DRAWINGS

FIG. 1 is a diagrammatic view illustrating an opening end of a converter housing in an embodiment of an automatic transmission (an automatic transaxle) made according to the invention, as viewed from the mating face of the converter housing opposite to a transmission case.

FIG. 2 is a diagrammatic view illustrating an opening end of the transmission case, as viewed from the mating face of the transmission case opposite to the converter housing.

FIG. 3 is a side view of the automatic transmission (the automatic transaxle), partially cross-sectioned.

FIG. 4 is an exploded view of an air breather chamber of the converter-housing side in the automatic transmission of the embodiment shown in FIGS. 1-3.

FIG. 5 is an exploded view of an air-breather chamber of the transmission-case side in the automatic transmission of the embodiment shown in FIGS. 1-3.

FIG. 6 is a partial cross-sectional view taken along the line A-A of the exploded view of FIG. 4.

FIG. 7 is a partial cross-sectional view taken along the line B-B of the exploded view of FIG. 4.

### DESCRIPTION OF THE PREFERRED EMBODIMENTS

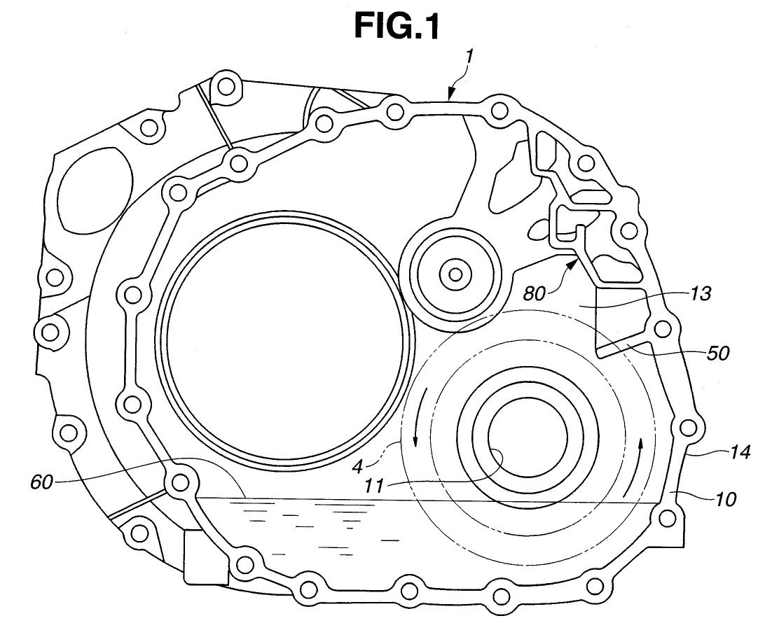

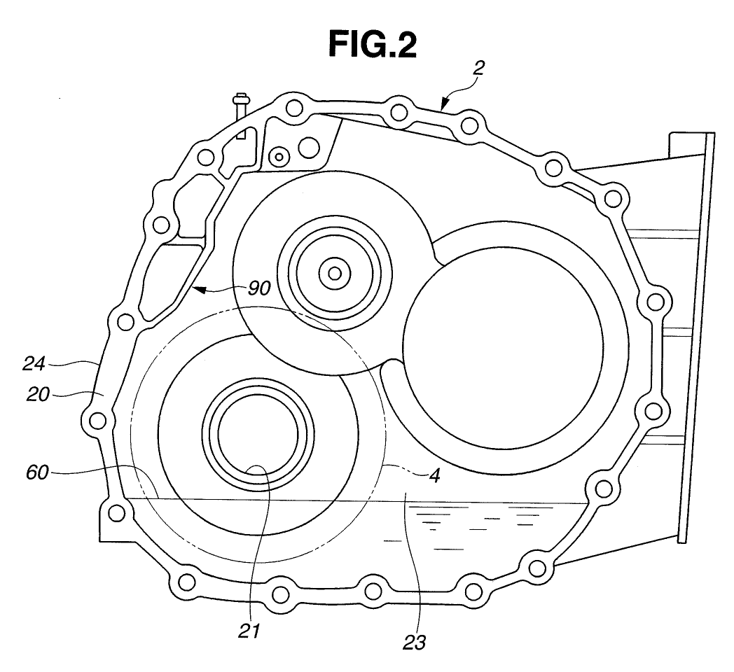

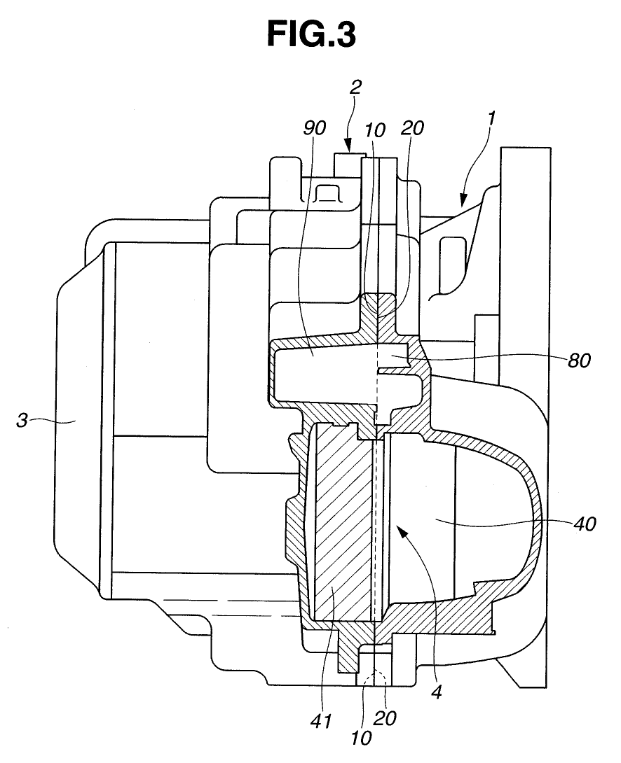

Referring now to the drawings, particularly to FIGS. 1-3, the air-breather equipped automatic transmission of the embodiment is exemplified in a continuously variable transaxle (CVT), which uses a torque converter. The casing assembly of the automatic transmission is constructed by a converter housing (a bell housing) 1 and a transmission case 2, integrally connected to each other with their mating faces. FIG. 1 is a diagrammatic view of converter housing 1 as viewed from the converter-housing side mating face 10, FIG. 2 is a diagrammatic view of transmission case 2 as viewed from the transmission-case side mating face 20, and FIG. 3 is the side view of the automatic transmission (CVT).

Additionally, as can be seen from the partial cutaway view of FIG. 3, a part of the side face of converter housing 1 and a part of the side face of transmission case 2 are cut out so as to clearly show an air breather chamber (a converter-housing side air breather chamber 80 and a transmission-case side air breather chamber 90, both described later), and a differential device 4 (one of transmission rotating component parts).

As clearly shown in FIG. 1, converter housing 1 has the converter-housing side mating face 10 formed on the substantially annular flanged opening end on this side (viewing FIG. 1) of a converter-housing outer peripheral wall 14. In a similar manner, as clearly shown in FIG. 2, transmission case 2 has the transmission-case side mating face 20 formed on the substantially annular flanged opening end on this side (viewing FIG. 2) of a transmission-case outer peripheral wall 24. As can be appreciated from the diagrammatic views of FIGS. 1-2, the substantially annular, flat converter-housing side mating face 10 and the substantially annular, flat transmission-case side mating face 20 are configured to be identical to each other in the surface shape and dimensions, such that, when assembling, these two mating faces 10 and 20 are just mated or fitted to each other.

As seen from the side view of FIG. 3, actually, converter housing 1 and transmission case 2 are integrally connected to each other by fastening the opposed mating faces 10 and 20 together with attaching bolts (not shown). Additionally, a side cover 3 is bolted to the opposite opening end or the left-hand opening end (viewing FIG. 3) of transmission case 2, facing apart from the mating face 20. A shifting mechanism is accommodated or housed in an internal space defined in the converter housing 1, transmission case 2, and side cover 3, to achieve an automatic shift of the automatic transmission.

Converter housing 1 is connected to an engine (not shown) at the opposite opening end or the right-hand opening end (viewing FIG. 3) of converter housing (bell housing) 1, facing apart from the mating face 10.

With the engine coupled, engine power output is transmitted through power-transmission parts, such as a transmission input shaft, a counter shaft and the like, which parts are supported by the converter housing 1, transmission case 2, and side cover 3, with a speed change (in other words, a torque increase in case of a speed reduction) and a change in rotational direction. Then, the speed-changed input rotation is further delivered to differential device 4, indicated by the phantom line in FIGS. 1-2. Axle shafts splined to respective bevel gears (differential side gears) of differential device 4 are supported by a converter-housing side differential axle-shaft support bore hole (simply, a housing-side shaft support bore) 11 (see FIG. 1) and a transmission-case side differential axle-shaft support bore hole (simply, a case-side shaft support bore) 21 (see FIG. 2).

As best seen in FIG. 3, regarding differential device 4, whose axle shafts are supported by housing-side shaft support bore 11 and case-side shaft support bore 21, a final-drive ring gear 41 of the differential is located at the side of transmission case 2, while a differential-gearing main component parts 40, containing at least differential pinions and a differential pinion shaft, are located at the side of converter housing 1.

As shown in FIGS. 1-2, oil (working fluid) is stored in the lower part of the internal space defined by the inner walls of converter housing 1 and transmission case 2. A level 60 of oil in the lower part of the internal space surrounded by converter housing 1 and transmission case 2 is adjusted not to exceed the lowermost end of each of housing-side shaft support bore 11 and case-side shaft support bore 21. The level 60 of oil stored in the transmission casing assembly, constructed by converter housing 1 and transmission case 2, is also adjusted such that the lower portion of differential device 4 (in particular, final-drive ring gear 41) is partially immersed in the stored oil. As indicated by the two arrows in FIG. 1, during a normal driving mode (at a forward driving mode), final-drive ring gear 41 of differential device 4 rotates counterclockwise. Owing to the counterclockwise rotation of the final-drive ring gear, oil is splashed or flung up along the right-hand wall surface of converter-housing outer peripheral wall 14.

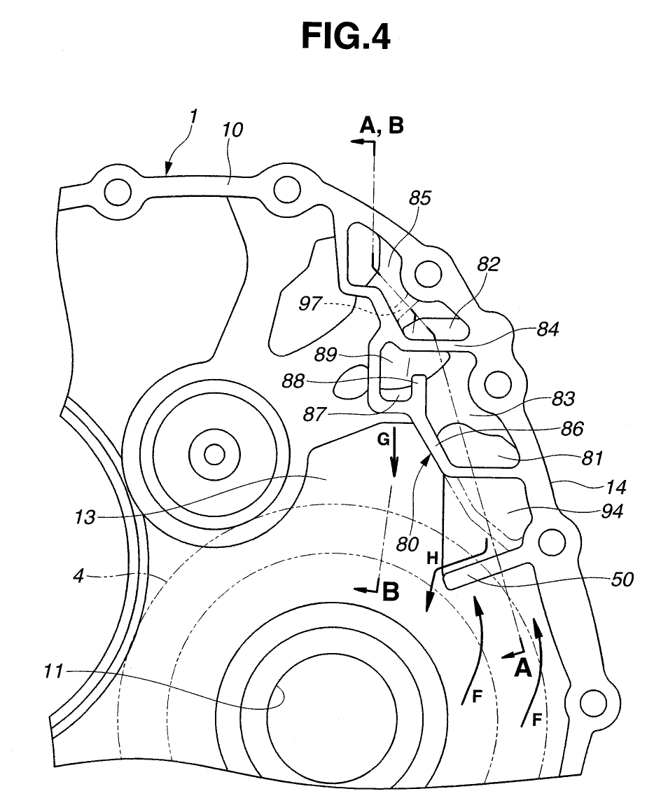

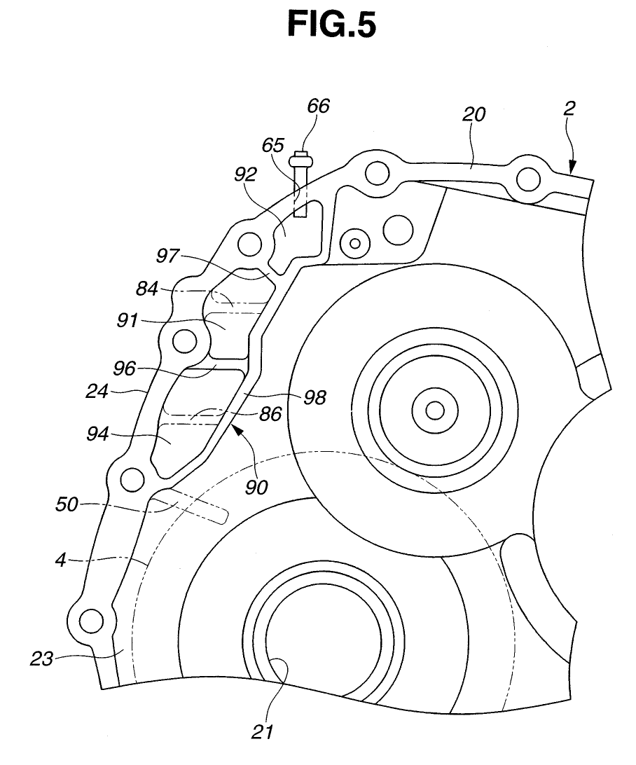

The detailed structure of the air breather (the air breathing mechanism) of the automatic transmission of the embodiment is hereunder described in reference to the exploded views of FIGS. 4-5.

In order to prevent oil bubbles from being forcibly discharged or spout out of an air breather hole 65 and also to effectively separate the oil (working fluid) and the gas (air) from each other and thus to exhaust only the gas (air) into the exterior space of the transmission casing assembly, the transmission casing assembly of the automatic transmission of the embodiment is formed with the air breather chamber (see converter-housing side air breather chamber 80 shown in FIG. 4 and transmission-case side air breather chamber 90 shown in FIG. 5) having a labyrinthine air-breathing space, which communicates with the inside opening of air breather hole 65.

As seen from the exploded view of transmission-case side air breather chamber 90 shown in FIG. 5, air breather hole 65 is located at the upper portion of transmission case 2 and arranged above differential device 4 in a manner so as to intercommunicate the internal space and the exterior space of the transmission casing assembly through air breather hole 65. As previously discussed, air breather hole 65 is provided to escape the internal pressure from the transmission casing assembly to the atmosphere and thus to reduce the pressure difference between inside and outside of the transmission casing assembly. In the shown embodiment, air breather hole 65 is bored in the upper portion of transmission case 2 in such a manner as to penetrate the transmission case. As best seen in FIG. 5, actually, a breather pipe 66 is inserted or fitted into air breather hole 65 formed in transmission case 2, and the outlet of breather pipe 66 is configured to be connectable to a hose (not shown).

Returning to FIG. 4, converter-housing side air breather chamber 80 is defined by converter-housing outer peripheral wall 14 and a housing-side inner rib 86, which rib is formed on a housing-side shaft support wall 13 of converter housing 1. Housing-side shaft support bore 11 is formed in housing-side shaft support wall 13. The previously-discussed converter-housing outer peripheral wall 14 extends from the peripheral rim of housing-side shaft support wall 13. In a similar manner, as seen in FIG. 5, transmission-case side air breather chamber 90 is defined by transmission-case outer peripheral wall 24 and a case-side inner rib 98, which rib is formed on a case-side shaft support wall 23 of transmission case 2. Case-side shaft support bore 21 is formed in case-side shaft support wall 23. The previously-discussed transmission-case outer peripheral wall 24 extends from the peripheral rim of case-side shaft support wall 23. As can be appreciated from the two exploded views of FIGS. 4-5, in a mated state (or in an assembled state) where the mating face 10 of converter housing 1 and the mating face 20 of transmission case 2 abut each other in a fluid-tight fashion, the mating face of housing-side inner rib 86 and the mating face of case-side inner rib 98 are just fitted to or in alignment with each other except a housing-side dripping hole 87 formed in the ribbed or webbed portions of converter-housing side air breather chamber 80 and a case-side dripping hole 94 formed in the ribbed or webbed portions of transmission-case side air breather chamber 90, so as to define a labyrinthine air-breathing space by converter-housing side air breather chamber 80 and transmission-case side air breather chamber 90 communicating with each other.

As seen in FIG. 4, a housing-side first partition rib 84 is formed on housing-side shaft support wall 13 within converter-housing side air breather chamber 80. Converter-housing outer peripheral wall 14 connects with housing-side inner rib 86 by means of housing-side first partition rib 84. A housing-side second partition rib 88 is further formed on housing-side shaft support wall 13 within converter-housing side air breather chamber 80 in such a manner as to extend upward (viewing FIG. 4) from housing-side inner rib 86.

Converter-housing side air breather chamber 80 is divided or partitioned into three sections, namely a housing-side first air breather chamber 81, a housing-side second air breather chamber 82, and a housing-side third air breather chamber 89, by means of both housing-side first partition rib 84 and housing-side second partition rib 88.

As can be appreciated from a short longitudinal length of housing-side second partition rib 88 upwardly extending from housing-side inner rib 86, housing-side third air breather chamber 89 is not completely partitioned from housing-side first air breather chamber 81. As seen from the exploded view of FIG. 4, the upper-half space of housing-side third air breather chamber 89 and the uppermost space of housing-side first air breather chamber 81 communicate each other. The mating face of housing-side first partition rib 84 and the mating face of housing-side second partition rib 88 are both formed or configured to be flush with the flat converter-housing side mating face 10.

A housing-side first raised portion 83 is formed on housing-side shaft support wall 13 within housing-side first air breather chamber 81, as an intermediate webbed portion extending from a part of housing-side inner rib 86 and housing-side second partition rib 88 to converter-housing outer peripheral wall 14.

A housing-side second raised portion 85 is formed on housing-side shaft support wall 13 within housing-side second air breather chamber 82, as an intermediate webbed portion extending from housing-side inner rib 86 to converter-housing outer peripheral wall 14.

The substantially flattened surface of each of housing-side first raised portion 83 and housing-side second raised portion 85, both formed on housing-side shaft support wall 13, is dimensioned to be lower than the flat converter-housing side mating face 10. Housing-side first raised portion 83 serves as a flow-constricting structure that partially throttles or reduces a fluid-flow passage area of housing-side first air breather chamber 81. Likewise, housing-side second raised portion 85 serves as a flow-constricting structure that partially throttles or reduces a fluid-flow passage area of housing-side second air breather chamber 82.

In the labyrinth-air-breather-chamber equipped automatic transmission of the embodiment, a shielding rib 50 is also provided or located at the lower position of converter-housing side air breather chamber 80 in such a manner as to extend from converter-housing outer peripheral wall 14 towards the inside of converter housing 1 (see the exploded view of converter-housing side air breather chamber 80 shown in FIG. 4). Shielding rib 50 inwardly extends from converter-housing outer peripheral wall 14 at an inclination angle that shielding rib 50 is slightly inclined downward with respect to the horizontal direction.

The detailed structure of transmission-case side air breather chamber 90 is hereunder described in reference to the exploded view of FIG. 5.

As seen in FIG. 5, a case-side partition rib 97 is formed on case-side shaft support wall 23 within transmission-case side air breather chamber 90. Transmission-case outer peripheral wall 24 connects with case-side inner rib 98 by means of case-side partition rib 97. The mating face of case-side partition rib 97 is formed or configured to be flush with the flat transmission-case side mating face 20.

Transmission-case side air breather chamber 90 is divided or partitioned into two sections, namely a case-side first air breather chamber 91 and a case-side second air breather chamber 92, by means of case-side partition rib 97.

A case-side raised portion 96 is formed on case-side shaft support wall 23 within case-side first air breather chamber 91, as an intermediate ribbed portion extending from case-side inner rib 98 to transmission-case outer peripheral wall 24.

The substantially flattened, elongated surface of case-side raised portion 96, formed on case-side shaft support wall 23, is dimensioned to be lower than the flat transmission-case side mating face 20. Case-side raised portion 96 serves as a flow-constricting structure that partially throttles or reduces a fluid-flow passage area of case-side first air breather chamber 91.

Air breather hole 65 communicates case-side second air breather chamber 92.

The ribbed portions indicated by phantom lines (two-dotted lines) in FIG. 4 correspond to the opposite ribs formed within transmission-case side air breather chamber 90 opposed to converter-housing side air breather chamber 80, in the mated state where the mating face 10 of converter housing 1 and the mating face 20 of transmission case 2 abut each other and thus converter-housing side air breather chamber 80 and transmission-case side air breather chamber 90 are in abutted-engagement with each other. On the other hand, the ribbed portions indicated by phantom lines (two-dotted lines) in FIG. 5 correspond to the opposite ribs formed within converter-housing side air breather chamber 80 opposed to transmission-case side air breather chamber 90, in the mated state. An integrated air breather chamber (in other words, two-split air breather chamber) 100 of a labyrinthine structure is formed by integrally connecting or abutting converter-housing side air breather chamber 80 (one of the two air-breather-chamber halves) and transmission-case side air breather chamber 90 (the other of the two air-breather-chamber halves).

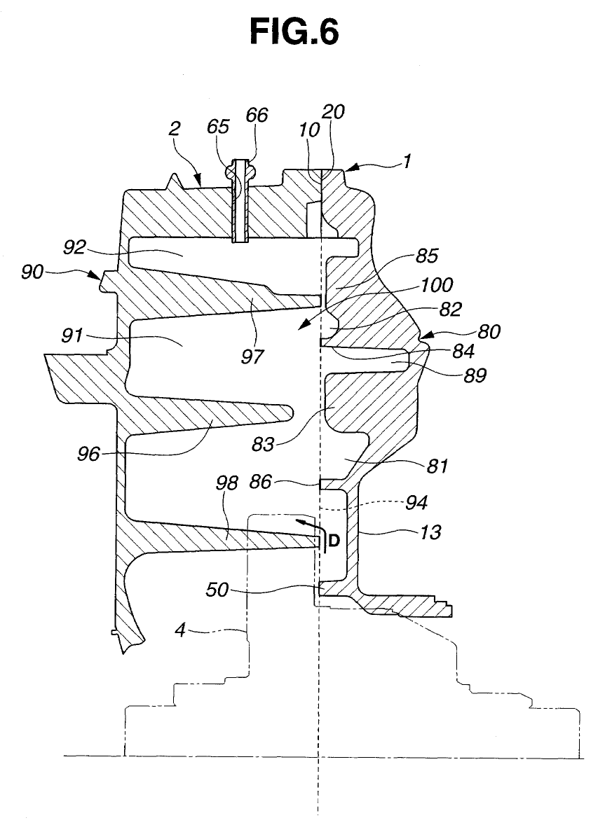

As seen in FIGS. 5 and 6, regarding the integrated air breather chamber (simply, air breather chamber) 100, the lower portion of case-side first air breather chamber 91 is formed as case-side dripping hole 94. Case-side dripping hole 94 is formed to extend to a lower level as compared to housing-side first air breather chamber 81 in such a manner as to open into the internal space of the transmission casing assembly of the automatic transmission.

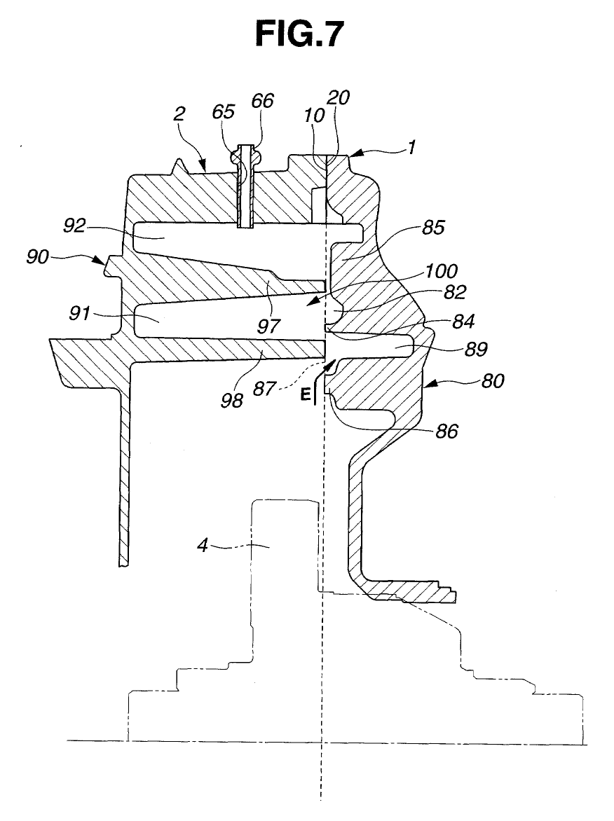

As seen in FIGS. 4 and 7, regarding air breather chamber 100, the lower portion of housing-side third air breather chamber 89 formed as housing-side dripping hole 87. Housing-side dripping hole 87 is formed to extend to a lower level as compared to case-side first air breather chamber 91 in such a manner as to open into the internal space of the transmission casing assembly of the automatic transmission.

As seen from the cross section of FIG. 6, case-side partition rib 97 of transmission-case side air breather chamber 90 and housing-side second raised portion 85 of converter-housing side air breather chamber 80 are formed or configured to be substantially opposed to each other. Case-side raised portion 96 of transmission-case side air breather chamber 90 and housing-side first raised portion 83 of converter-housing side air breather chamber 80 are formed or configured to be substantially opposed to each other. As best seen in FIG. 7, there is a predetermined clearance space defined between case-side partition rib 97 and housing-side second raised portion 85. In a similar manner, as best seen in FIG. 6, there is a predetermined clearance space defined between case-side raised portion 96 and housing-side first raised portion 83. Each of these clearance spaces is formed or shaped to serve as a flow-constriction fixed orifice (a flow-constricting structure) that partially throttles or reduces a fluid-flow passage area of air breather chamber 100 of the labyrinthine structure so as to properly regulate the flow velocity of fluid passing through the partially-throttled clearance space of the labyrinthine air-breathing space.

As can be seen in FIG. 6, case-side first air breather chamber 91, housing-side first air breather chamber 81, and the lower portion (located below housing-side second raised portion 85) of housing-side second air breather chamber 82 are spatially communicated with each other. Case-side second air breather chamber 92 and the upper portion of housing-side second air breather chamber 82 are spatially communicated with each other. The lower portion (located below case-side raised portion 96) of case-side first air breather chamber 91 is communicated with the internal space of the transmission casing assembly of the automatic transmission through case-side dripping hole 94.

According to the labyrinth-air-breather-chamber equipped automatic transmission of the embodiment, shielding rib 50 is provided or located at the lower position of air breather chamber 100, such that shielding rib 50 is located at a level lower than the lowermost end of case-side dripping hole 94, and that shielding rib 50 extends from housing-side shaft support wall 13 of converter-housing side air breather chamber 80 to case-side dripping hole 94 of transmission-case side air breather chamber 90 (see the cross section of FIG. 6).

Returning to FIG. 4, during the normal driving mode (at the forward driving mode) at which final-drive ring gear 41 of differential device 4 is rotating counterclockwise, oil (working fluid) is splashed or flung up along the inside wall surface (the right-hand side wall surface) of converter-housing outer peripheral wall 14, as indicated by the arrows F.

In the labyrinth-air-breather-chamber equipped automatic transmission of the embodiment, shielding rib 50 is formed on the inside wall of converter housing 1 and located in close proximity to the lowermost end of case-side dripping hole 94 and laid out to be lower than the dripping-hole lowermost end. By the provision of shielding rib 50, there is a less risk that oil, splashed or flung up by rotary motion of final-drive ring gear 41 of differential device 4 (that is, the oil thrown or splashed in the directions F in FIG. 4), directly enters air breather chamber 100 through case-side dripping hole 94 (see FIG. 6).

By virtue of shielding rib 50, only the oil bubbles are permitted to enter air breather chamber 100 through case-side dripping hole 94. Additionally, the oil (working fluid) separated from the gas (air), using the labyrinthine structure of air breather chamber 100, can be efficiently returned or dripped into the internal space of the transmission casing assembly.

As seen in FIG. 7, the upper portion of housing-side third air breather chamber 89 is spatially communicated with case-side first air breather chamber 91. Additionally, the lower portion of housing-side third air breather chamber 89 is spatially communicated with the internal space of the transmission casing assembly of the automatic transmission through housing-side dripping hole 87.

The flow of oil bubbles is hereinafter described in detail in reference to the cross sections shown in FIGS. 6-7.

When the internal pressure in the transmission casing assembly of the automatic transmission rises under a state where oil stored in the casing assembly is agitated by rotation of the transmission rotating parts, such as final-drive ring gear 41 of differential device 4, and thus oil bubbles have already been produced, as indicated by the arrow D in FIG. 6, the oil bubbles tends to enter case-side first air breather chamber 91 through case-side dripping hole 94.

By the provision of shielding rib 50 formed or located as discussed above, it is possible to assure at least two appropriate functions of case-side dripping hole 94 (one being a function that the oil bubbles are introduced into air breather chamber 100 through dripping hole 94 and the other being a function that the liquid oil separated from the gas (air) is returned into the internal space of the transmission casing assembly through dripping hole 94), while preventing the oil, splashed or flung up by final-drive ring gear 41 of differential device 4 (that is, the oil thrown or splashed in the directions F in FIG. 4), from directly reaching case-side dripping hole 94.

Additionally, owing to the internal pressure rise during operation of the automatic transmission, as indicated by the arrow E in FIG. 7, the oil bubbles further enter housing-side third air breather chamber 89 through housing-side dripping hole 87.

When the oil bubbles are rising to air breather hole 65, the oil bubbles flow here and there among the housing-side first air breather chamber 81, housing-side second air breather chamber 82, housing-side third air breather chamber 89, case-side first air breather chamber 91 and case-side second air breather chamber 92.

By way of the flow of oil bubbles, introduced into air breather chamber 100 through case-side dripping hole 94 and/or housing-side dripping hole 87 and then flowing in various fluid-flow directions within the labyrinthine space defined by the ribbed converter-housing side air breather chamber 80 and the ribbed transmission-case side air breather chamber 90, in other words, by way of the labyrinthine effect, oil (working fluid) and gas (air), entering the integrated air breather chamber in the form of oil bubbles, can be certainly separated from each other.

After the gas (air) separated from the oil (working fluid) has reached case-side second air breather chamber 92, the gas (air) is exhausted from breather pipe 66 inserted or fitted into air breather hole 65 into the exterior space of the automatic transmission. On the other hand, the oil (working fluid) separated from the gas (air) is returned through housing-side dripping hole 87 and/or case-side dripping hole 94 into the outside space of air breather chamber 100 (that is, into the interior space of the automatic transmission).

As indicated by the arrow G in FIG. 4, oil dripping through housing-side dripping hole 87 is supplied directly to differential device 4 for lubrication. On the other hand, oil dripping through case-side dripping hole 94 falls temporarily on the upside of shielding rib 50. As viewed in the axial direction of final-drive ring gear 41 of differential device 4, shielding rib 50 is formed to be slightly inclined downward with respect to the horizontal direction and oriented toward differential device 4. Thus, the oil, dripping temporarily on the upside of shielding rib 50, is rapidly routed and dripped toward differential device 4, as indicated by the arrow H in FIG. 4, for lubrication.

In the labyrinth-air-breather-chamber equipped automatic transmission of the embodiment, converter housing 1 serves as a first casing of the transmission casing assembly, transmission case 2 serves as a second casing of the transmission casing assembly, and case-side dripping hole 94 serves as an air-breather opening (or an air-breather inlet-and-return port).

As will be appreciated from the above, according to the labyrinth-air-breather-chamber equipped automatic transmission of the embodiment, shielding rib 50 is provided below case-side dripping hole 94 through which oil bubbles enter air breather chamber 100 in such a manner as to be downwardly inclined to differential device 4. Shielding rib 50 serves to prevent oil, splashed or thrown by differential device 4, from directly entering air breather chamber 100 through case-side dripping hole 94. Shielding rib 50 also serves to rapidly feed or deliver oil dripping through case-side dripping hole 94 on the upside of shielding rib 50 toward differential device 4 by way of an appropriate inclination of shielding rib 50 inclined with respect to the horizontal line. This enhances the lubricating performance for differential device 4.

Even when oil, stored in the transmission casing assembly, is shaking owing to vibrations of a vehicle body during driving, shielding rib 50 functions to prevent the shaking oil from directly reaching case-side dripping hole 94.

Furthermore, shielding rib 50, which rib serves to shield or prevent oil splashed by differential device 4 from reaching case-side dripping hole 94, is integrally formed on housing-side shaft support wall 13 and converter-housing outer peripheral wall 14 in such a manner as to extend substantially perpendicularly to each wall surface of these walls 13-14. Shielding rib 50 also contributes to an enhanced rigidity of a wall surface portion of converter housing 1, extending from housing-side shaft support bore 11 to air breather chamber 100. By virtue of the properly enhanced rigidity of the wall surface portion of converter housing 1 realized by addition of shielding rib 50, it is possible to effectively reduce radial noise, arising from oscillations of housing-side shaft support wall 13. Additionally, the properly enhanced rigidity of converter housing 1, realized by addition of shielding rib 50, also contributes to an enhanced sealing performance between the flat mating face 10 of converter housing 1 and the flat mating face 20 of transmission case 2 just fitted to each other when assembling.

In the shown embodiment, shielding rib 50 is formed only on the converter housing side. The installation position (or the formation position) of shielding rib 50 may be suitably changed or modified depending on the positional relationship of air breather chamber 100 and differential device 4. For instance, shielding rib 50 may be formed on the transmission case side and arranged at the lower position of transmission-case side air breather chamber 90. Alternatively, shielding rib 50 may be formed on each of converter housing 1 and transmission case 2.

Moreover, in the shown embodiment, shielding rib 50 is integrally formed with converter housing 1. In lieu thereof, when assembling, shielding rib 50 may be installed in place as a separate member so that shielding rib 50 is fixedly connected to the inner wall of either one of converter housing 1 and transmission case 2. From the viewpoint of light weight, it is more preferable that shielding rib 50 is integrally formed on the inner wall of the transmission casing assembly 1-2.

The entire contents of Japanese Patent Application No. 2006-186371 (filed Jul. 6, 2006) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. An automatic transmission comprising:
a transmission casing assembly accommodating therein at least one transmission rotating component part;
an air breather chamber provided in the transmission casing assembly for separating oil and air, entering the air breather chamber as oil bubbles;
an air breather hole formed in the transmission casing assembly in such a manner as to penetrate the transmission casing assembly for communicating the air breather chamber with an exterior space of the transmission casing assembly through the air breather hole;
an air-breather opening that intercommunicates an internal space of the transmission casing assembly and the air breather chamber; and
a shielding rib located below the air-breather opening and extending from an inner wall of the transmission casing assembly, for preventing oil, stored in the transmission casing assembly, from directly reaching the air-breather opening, an upside of the shielding rib being configured to be inclined downwardly with respect to a horizontal line in such a manner as to be oriented toward the transmission rotating component part, for receiving oil dripping through the air-breather opening with the upside of the shielding rib and for delivering the received oil toward the transmission rotating component part, using the inclined upside of the shielding rib.

2. The automatic transmission as claimed in claim 1, wherein:
the transmission casing assembly comprises a first casing having a first shaft support wall supporting a first axial end of the transmission rotating component part and a first outer peripheral wall extending from a peripheral rim of the first shaft support wall, and a second casing having a second shaft support wall supporting a second axial end of the transmission rotating component part and a second outer peripheral wall extending from a peripheral rim of the second shaft support wall;
the transmission casing assembly is constructed by integrally connecting an opening end of the first casing and an opening end of the second casing to each other; and
the shielding rib formed on the shaft support wall and the outer peripheral wall of either one of the first and second casings in such a manner as to extend substantially perpendicularly to wall surfaces of the shaft support wall and the outer peripheral wall.

3. The automatic transmission as claimed in claim 1, wherein:
the air breather chamber is arranged above the transmission rotating component part; and
the shielding rib is located in close proximity to and below the air-breather opening, for preventing oil, stored in the transmission casing assembly and splashed by rotary motion of the transmission rotating component part, from directly reaching the air-breather opening.

4. The automatic transmission as claimed in claim 1, wherein:
the transmission rotating component part is a differential device.

5. An automatic transmission comprising:
a transmission casing assembly accommodating therein at least one transmission rotating component part and comprising a converter housing having a mating face formed on an opening end and a transmission case having a mating face formed on an opening end, both of the mating faces fitted to each other when assembling;
an integrated air breather chamber provided in the transmission casing assembly and located adjacent to the mating faces and comprising a converter-housing side air breather chamber and a transmission-case side air breather chamber integrally connected to each other for defining a labyrinthine air-breathing space and for separating oil and air, entering the air breather chamber as oil bubbles;
an air breather hole formed in the transmission casing assembly in such a manner as to penetrate the transmission casing assembly for communicating the air breather chamber with an exterior space of the transmission casing assembly through the air breather hole;
an air-breather opening that intercommunicates an internal space of the transmission casing assembly and the air breather chamber; and
a shielding rib located below the air-breather opening and extending from an inner wall of the transmission casing assembly, for preventing oil, stored in the transmission casing assembly, from directly reaching the air-breather opening, an upside of the shielding rib being configured to be inclined downwardly with respect to a horizontal line in such a manner as to be oriented toward the transmission rotating component part, for receiving oil dripping through the air-breather opening with the upside of the shielding rib and for delivering the received oil toward the transmission rotating component part, using the inclined upside of the shielding rib.

6. The automatic transmission as claimed in claim 5, wherein:
the shielding rib is integrally formed with the inner wall of the transmission casing assembly.

7. The automatic transmission as claimed in claim 6, wherein:
the converter-housing side air breather chamber is defined by at least two ribbed portions and at least one raised portion formed on the inner wall of the converter housing and extending from a converter-housing outer peripheral wall;
the transmission-case side air breather chamber is defined by at least two ribbed portions and at least one raised portion formed on the inner wall of the transmission case and extending from a transmission-case outer peripheral wall; and
the ribbed portions and the raised portion of the converter-housing side air breather chamber and the ribbed portions and the raised portion of the transmission-case side air breather chamber cooperate with each other for defining the labyrinthine air-breathing space.

8. The automatic transmission as claimed in claim 7, wherein:
each of the raised portion of the converter-housing side air breather chamber and the raised portion of the transmission-case side air breather chamber is configured to provide a flow-constriction orifice that partially throttles the labyrinthine air-breathing space.
